(19) United States
(12) Patent Application Publication
(10) Pub. No.: US 2014/0095913 A1
(43) Pub. Date: Apr. 3, 2014

(54) ELECTRONIC APPARATUS

(71) Applicant: WISTRON CORPORATION, New Taipei City (TW)

(72) Inventor: Ting-Lung Lin, New Taipei City (TW)

(73) Assignee: Wistron Corporation, New Taipei City (TW)

(21) Appl. No.: 13/887,481

(22) Filed: May 6, 2013

(30) Foreign Application Priority Data
Sep. 28, 2012 (TW) 101135862

(51) Int. Cl. G06F 1/32

(52) U.S. Cl. CPC G06F 1/3234
USPC 713/323

(57) ABSTRACT

An electronic apparatus is disclosed. The electronic apparatus comprises a capacitive sensor and a central processing unit (CPU). The capacitive sensor comprises a sensor output pin, and the CPU comprises a wake-up pin. The wake-up pin is coupled to the sensor output pin.

This application claims the benefit of Taiwan application Serial No. 101135862, filed Sep. 28, 2012, the subject matter of which is incorporated herein by reference.

### BACKGROUND OF THE INVENTION

1. Field of the Invention

The invention relates in general to an electronic apparatus, and more particularly to an electronic apparatus using a capacitive sensor.

2. Description of the Related Art

In a modern information society with advanced development of technology, electronic apparatus has been widely used in people's everydayness. With the electronic apparatus, people can conveniently exchange information, share experience or communicate opinions whenever and wherever it is needed. For example, the user can answer incoming calls, check messages or mails with an electronic apparatus. If the user is unable to answer the incoming calls or check the messages or mails, the electronic apparatus will then enter a standby mode.

When the electronic apparatus is in a standby mode, the user needs to open the frame of the electronic apparatus to check whether there are any pending events. Examples of the pending events include missed calls, new messages or new mails. Or, the electronic apparatus periodically sends a tone to inform the user of the pending event. However, it is inconvenient for the user to open the frame of the electronic apparatus to check whether there are any pending events. The way of periodically sending a tone by the electronic apparatus will incur unnecessary power consumption. Therefore, how to make the user more conveniently use the electronic apparatus and save unnecessary power consumption has become a prominent task for the industries.

### SUMMARY OF THE INVENTION

The invention is directed to an electronic apparatus.

According to an embodiment of the present invention, an electronic apparatus is disclosed. The electronic apparatus comprises a capacitive sensor and a central processing unit (CPU). The capacitive sensor comprises a sensor output pin, and the CPU comprises a wake-up pin. The wake-up pin is coupled to the sensor output pin.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 shows a block diagram of an electronic apparatus according to a first embodiment;

FIG. 2 shows an execution flowchart of an electronic apparatus; and

FIG. 3 shows a block diagram of an electronic apparatus according to the second embodiment.

### DETAILED DESCRIPTION OF THE INVENTION

### First Embodiment

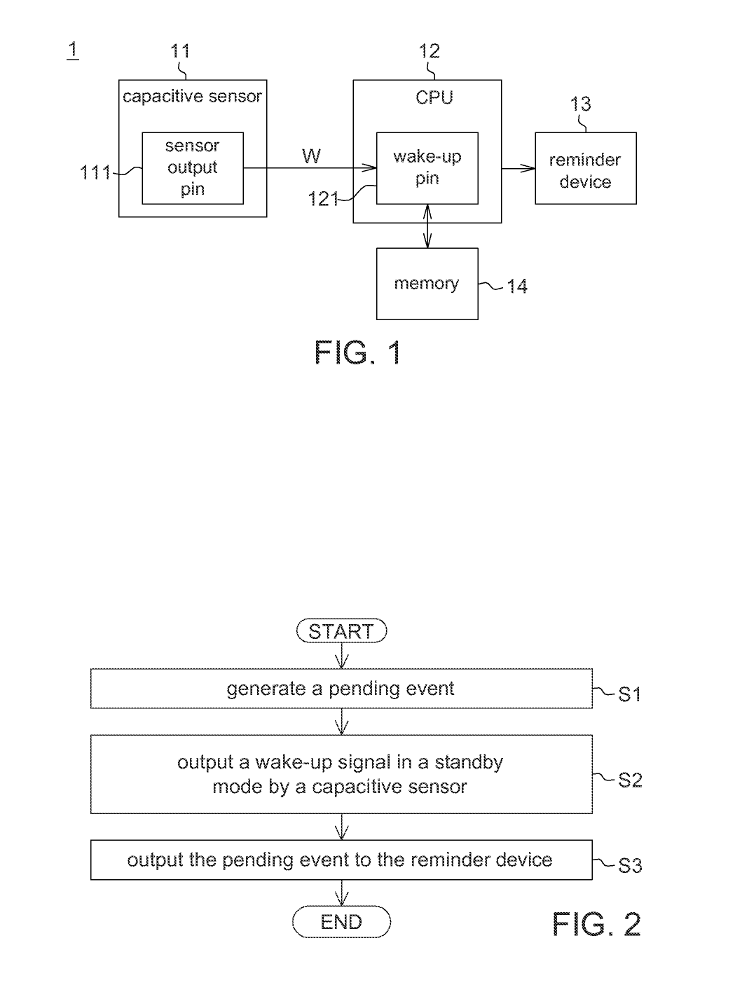

Referring to FIG. 1, a block diagram of an electronic apparatus according to a first embodiment is shown. The electronic apparatus 1 can be realized by such as a multi-media player, a tablet PC, a mobile communication device or other portable electronic apparatuses. The electronic apparatus 1 comprises a capacitive sensor 11, a central processing unit (CPU) 12, a reminder device 13 and a memory 14. The capacitive sensor 11 can be realized by such as a proximity sensor (p sensor). When the user approaches, the capacitive sensor 11 generates a capacitance change and correspondingly outputs a wake-up signal W. The capacitive sensor 11 comprises a sensor output pin 111, and the CPU 12 comprises a wake-up pin 121. The wake-up pin 121, which is also referred as wake-up event input, is coupled to the sensor output pin 111. The CPU 12 is coupled to the reminder device 13 and the memory 14. The memory 14 stores a pending event, and the reminder device 13 reminds and informs the user of the pending event. The pending event is such as a missed call, a new message or a new mail. The reminder device 13 can be realized by such as a monitor, a speaker, a vibration device or a light emitting diode.

Referring to both FIG. 1 and FIG. 2. FIG. 2 shows an execution flowchart of an electronic apparatus. The execution flowchart of the electronic apparatus 1 comprises the following steps: Firstly, as indicated in step S1, the CPU 12 generates a pending event and further stores the pending event to the memory 14. Next, as indicated in step S2, when the capacitive sensor 11 detects a capacitance change in a standby mode, the capacitive sensor 11 outputs a wake-up signal W to the wake-up pin 121 of the CPU 12 via the sensor output pin 111. Then, as indicated in step S3, the CPU 12 reads the pending event from the memory 14 and further outputs the pending event to the reminder device 13 to inform and remind the user of the pending event. The reminder device 13 such as informs and reminds the user with a frame, a tone or a vibration.

### Second Embodiment

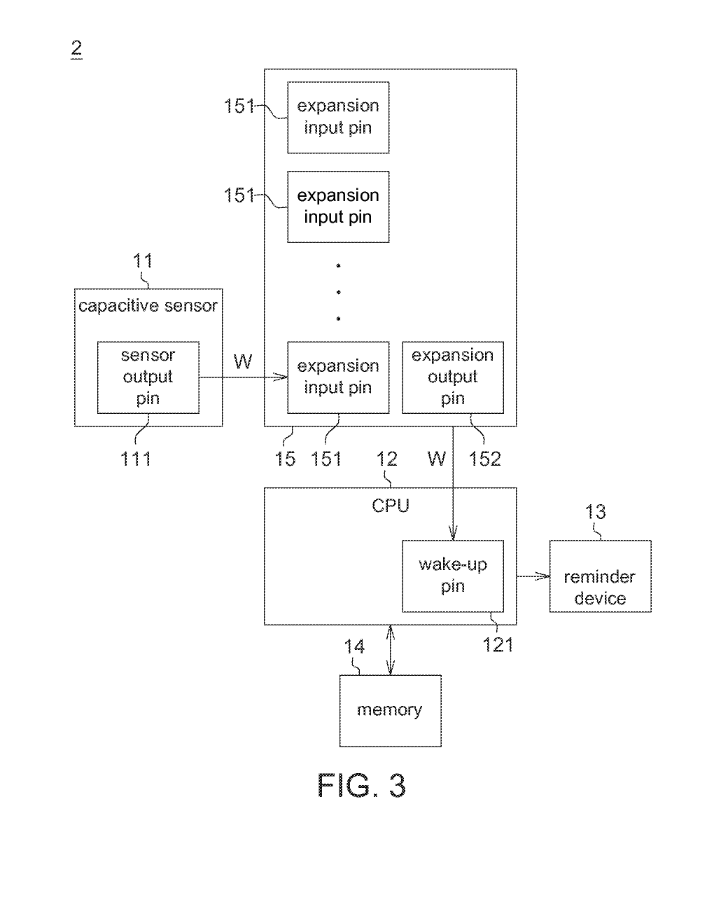

Referring to FIG. 1 and FIG. 3. FIG. 3 shows a block diagram of an electronic apparatus according to the second embodiment. The electronic apparatus 2 is different from the electronic apparatus 1 mainly in the electronic apparatus 2, and further comprises a pin expansion element 15. The pin expansion element 15 can be realized by such as a general purpose input/output (GPIO) expander, a keyboard controller or a micro-processor. The pin expansion element 15 comprises several expansion input pins 151 and expansion output pin 152. One of the expansion input pins 151 is electrically connected to the sensor output pin 111 to receive the wake-up signal W, and the remaining expansion input pins 151 can be used by other elements, such as a Wi-Fi chip or a power button, which needs to output the wake-up signal to the CPU 12. The expansion output pin 152 is electrically connected to the wake-up pin 121 to output the wake-up signal W to the CPU 12. Since the number of the wake-up pins 121 of the CPU 12 is limited, the pin expansion element 15 can make more elements coupled to the wake-up pins 121 of the CPU 12.

In the above embodiments, the capacitive sensor detects whether the user approaches and further outputs the wake-up signal to the CPU to output the pending event to the reminder device when the user approaches. By doing so, only when the user approaches the electronic apparatus 1 will the reminder device 13 remind the user of the pending event. Therefore, the reminder device 13 does not periodically display the pending event, hence reducing unnecessary power consumption.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic apparatus, comprising:
a capacitive sensor, comprising:
a sensor output pin; and
a central processing unit (CPU), comprising:
a wake-up pin coupled to the sensor output pin.

2. The electronic apparatus according to claim 1, further comprising:
a pin expansion element, comprising:
an expansion input pin electrically connected to the sensor output pin; and
an expansion output pin electrically connected to the wake-up pin.

3. The electronic apparatus according to claim 2, wherein the pin expansion element is a general purpose input/output expander, a keyboard controller or a micro-processor.

4. The electronic apparatus according to claim 1, wherein when the capacitive sensor detects a capacitance change in a standby mode, the capacitive sensor outputs a wake-up signal to the wake-up pin via the sensor output pin.

5. The electronic apparatus according to claim 4, further comprising:
a reminder device coupled to the CPU, wherein the CPU outputs a pending event to the reminder device according to the wake-up signal.

6. The electronic apparatus according to claim 1, wherein the capacitive sensor is a proximity sensor.
